(19) United States
(12) Patent Application Publication
(10) Pub. No.: US 2024/0176141 A1
(43) Pub. Date: May 30, 2024

(54) FULL COLOR OPTICAL COMBINER FOR VIRTUAL REALITY OR AUGMENTED REALITY HEADSET OR HEADS-UP DISPLAY OR SIMILAR DEVICE

(71) Applicant: KENT STATE UNIVERSITY, Kent, OH (US)

(72) Inventors: Fenglin Xi, Cuyahoga Falls, OH (US); Philip Bos, Hudson, OH (US); Hsien-Hui Cheng, Redmond, WA (US); Lu Lu, Redmond, WA (US)

(21) Appl. No.: 18/519,643

(22) Filed: Nov. 27, 2023

Related U.S. Application Data
(63) Continuation of application No. 63/428,294, filed on Nov. 28, 2022.

(51) Int. Cl. G02B 27/01; G02B 27/10

(52) U.S. Cl. CPC G02B 27/0103; G02B 27/0179; G02B 27/1006; G02B 2027/0187

(57) ABSTRACT

An optical combiner includes first, second, and third polarization volume holograms (PVHs) configured to deflect light of a first color, a second color, and a third color, respectively. The optical combiner further includes a first polarization interference filter (PIF) configured to switch light of the first color from a polarization that is not deflected by the first PVH to a polarization that is deflected by the first PVH. The optical combiner may further include a second PIF configured to switch light of the second color from a polarization that is not deflected by the second PVH to a polarization that is deflected by the second PVH. The optical combiner may further include a third PIF configured to switch light of the third color from a polarization that is not deflected by the third PVH to a polarization that is deflected by the third PVH.

This application claims priority to U.S. Provisional Patent Application Ser. No. 63/428,294 filed Nov. 28, 2022. U.S. Provisional Patent Application Ser. No. 63/428,294 filed Nov. 28, 2022 is incorporated herein by reference in its entirety.

### BACKGROUND

The following relates to the optical combiner arts, stereoscopic display arts, virtual reality (VR) arts, augmented reality (AR) arts, heads-up display (HUD) arts, and related arts.

In AR, VR and HUD devices, an optical combiner allows the viewer to see a computer-generated image overlayed on the image of the real world. In some designs for applications such as AR, the viewer sees a combination of the real world whose light is transmitted through the optical combiner and virtual content that is deflected from the optical combiner. The optical combiner is transparent for light coming through but deflects light coming from a projector on the viewer side of the device. Hence, the optical combiner operates to combine the real world view and the projected content.

In some designs, the optical combiner comprises a holographic device that is typically made from surface relief gratings or volume holograms. In the case of volume holograms, the optical effect is based on the Bragg reflector concept. (A Bragg reflector is a material that has a periodically modulated index of refraction). In another approach, liquid crystal (LC) technology can be used to produce volume holograms that are sensitive to the circular polarization state of light (CPVHs), that adds versatility to the system design.

However, such optical combiner designs provide wavelength sensitive deflection, unlike a mirror. In other words, while a mirror reflects all colors into the same reflection angle (e.g., angle of reflection equal to angle of incidence), a polarization volume hologram (PVH) deflects light of different colors incident at the same angle of incidence into different deflected angles. That is, light of different wavelengths are deflected by the PVH into different angles, for the same angle of incidence. In this case a white image produced by the projector will be seen by the user as a separated primary color image.

As a more specific example, a single layer PVH combiner used in a Maxwellian view optical system as described in Jang, Bang, Li, and Lee, “Holographic near-eye display with expanded eye-box”, ACM Trans. Graph. 37, 6, Article 195 (November 2018) (hereinafter “Jang”). More generally, a wide angle deflector can be used whenever the color crosstalk is a problem, for example in a waveguide AR/VR system. In the illustrative example of a Maxwellian view optical system, eyeball rotation (and hence corresponding pupil movement) is accommodated by moving the projector toward or away from the PVH. While this enables the deflected ray to track the pupil location, it also changes the angle of incidence of light from the projector onto the PVH. Hence, the PVH should be designed to have a wide angle of acceptance. Moreover, the PVH combiner is designed for a single wavelength, and hence will deflect light at wavelengths other than the design-basis wavelength into different deflected angles. This difference in the deflected angle for different incident wavelengths causes a chromatic aberration due to the spatial separation of the colors of the image. For a full color display, it is desired for the PVH to operate over the entire visible spectrum, for example as represented by the three primary colors: blue light (e.g., 450 nm), green light (e.g., 525 nm), and red light (e.g., 635 nm). This cannot be accomplished using a single PVH.

### BRIEF SUMMARY

In some nonlimiting illustrative embodiments, an optical combiner includes: a first polarization volume hologram (PVH) configured to deflect light of a first color; a second PVH configured to deflect light of a second color that is different from the first color; a third PVH configured to deflect light of a third color that is different from the first and second colors; and a first polarization interference filter (PIF) configured to switch light of the first color from a polarization that is not deflected by the first PVH to a polarization that is deflected by the first PVH. The optical combiner may optionally further include a second PIF configured to switch light of the second color from a polarization that is not deflected by the second PVH to a polarization that is deflected by the second PVH. The optical combiner may optionally further include a third PIF configured to switch light of the third color from a polarization that is not deflected by the third PVH to a polarization that is deflected by the third PVH.

In some nonlimiting illustrative embodiments, an optical combiner includes: a first PVH configured to deflect light of a first color that has the first polarization and configured to not deflect light of any color that has the second polarization; a second PVH configured to deflect light of a second color that has the first polarization and configured to not deflect light of any color that has the second polarization; a third PVH configured to deflect light of a third color that has the first polarization and configured to not deflect light of any color that has the second polarization; a first PIF configured to switch light of the first color from the second polarization to the first polarization; a second PIF configured to switch light of the second color from the second polarization to the first polarization; and a third PIF configured to switch light of the third color from the second polarization to the first polarization. The order of the structures with respect to the light source is the first PIF, first PVH, second PIF, second PVH, third PIF, third PVH.

### BRIEF DESCRIPTION OF THE DRAWINGS

FIG. 1 diagrammatically illustrates a Maxwellian view optical system and a detail view of an optical combiner thereof.

FIG. 2 diagrammatically illustrates the green PVH with circular polarized light input (CPVH-G) layer of the optical combiner of FIG. 1.

FIG. 3A shows the angle of acceptance of an illustrative CPVH-G whose thickness is 2 microns.

FIGS. 3B and 3C show simulated spectra for the CPVH-G of FIG. 3A, for an incident angle of 50.87 degrees (FIG. 3B) and for an incident angle of 66.6 degrees (FIG. 3C).

FIG. 4 diagrammatically shows an exploded side-sectional view of the optical combiner of FIG. 1.

FIG. 5 diagrammatically shows an exploded side-sectional view of an optical combiner with only two polarization interference filter (PIF) layers.

FIG. 6 diagrammatically shows an exploded side-sectional view of an optical combiner with only one PIF layer.

### DETAILED DESCRIPTION

A partial resolution of the problem of providing a full color optical combiner for use in a Maxwellian view optical system is to utilize three PVH layers, one designed for blue light, another for green light, and a third for red light. Thus, one PVH layer is designed to deflect green light to the desired angle, another PVH layer is designed to deflect blue light to the same desired angle, and a third PVH layer is designed to deflect red light to the same desired angle. In such a three-layer optical combiner, each respective layer is designed to be wavelength-selective for the design-basis wavelength. That is, green light should deflect from the green PVH layer, but pass unaffected through the red and blue PVH layers. Thus, each PVH layer is designed to make its respective deflection bandwidth sufficiently narrow enough so that it only deflects light of the design-basis wavelength/color.

But there is a problem with this solution. To design a PVH with a narrow bandwidth of deflection wavelengths, the main parameter that is adjusted to obtain this is to lower the degree of index modulation. Xiao Xiang and Michael J. Escuti, “Numerical analysis of Bragg polarization gratings,” J. Opt. Soc. Am. B 36, D1-D8 (2019) have shown that with increasing birefringence, there is a monotonic increase in both the spectral bandwidth and the angle of acceptance. This leads to a fundamental problem related to the physics of these devices, namely that they cannot simultaneously be designed to have a sufficiently narrow spectral bandwidth to avoid cross-talk between the red, green, and blue PVH layers, while also maintaining high efficiency over a sufficiently wide range of incident light angles to accommodate the movement of the projector toward/away from the PVH in the Maxwellian view optical system framework.

Put another way, by reducing the degree of index modulation to achieve red, green, and blue PVH layers with sufficiently narrow spectral bandwidth, this reduction in index modulation unfortunately also reduces the angle of acceptance of the PVH layers (i.e., the range of angles over which high deflection efficiency is maintained). Hence, while the PVH layers may have sufficiently narrow spectral bandwidth to avoid unacceptable color crosstalk (e.g., the design-basis red PVH layer may have a sufficiently narrow bandwidth so that it does not also deflect green light, for example), the angle of acceptance is reduced to an extent that deflection efficiency is unacceptably lowered over the limits of the movement of the projector of the Maxwellian view optical system.

In embodiments disclosed herein, the problem of providing a wide angle full color optical combiner is solved by using a synergistic combination of a PVH the responds to one state of circularly polarized light that we refer to here as a CPVH device (or, in other embodiments, linear PVH devices) and polarization interference filters (PIFs). Such PIFs are used in astronomical spectrometers, and have the property of changing the polarization state of light from one state of polarization to an orthogonal state for a narrow range of wavelengths. Outside of that narrow range, light is passed without effect. In optical combiners disclosed herein, PIF devices are paired with CPVH devices to provide an optical combiner that simultaneously deflects red, green and blue light to the same angle, and can do this for a wide range in incident angles.

Astronomical PIFs are typically designed to switch linearly polarized light from one linear polarization to an orthogonal linear polarization. By contrast, PVH layers used in optical combiners for a Maxwellian view optical system are sometimes constructed using liquid crystal (LC) or other layers that manipulate circularly polarized light (referred to herein as CPVH devices or layers). Each CPVH layer deflects light within a spectral bandwidth of one circular polarization state and transmits (unaffected) light of the orthogonal polarization state. Therefore, a PIF that affects the state of linear polarization is not directly suitable for use with such CPVH layers. To ensure compatibility between the PIF and CPVH devices, the PIF is also designed to operate with circularly polarized light (referred to herein as a CPIF). The CPIF switches the circular polarization state of narrow range of incident wavelengths to the orthogonal polarization state, while not affecting the polarization state of light outside of the wavelength range.

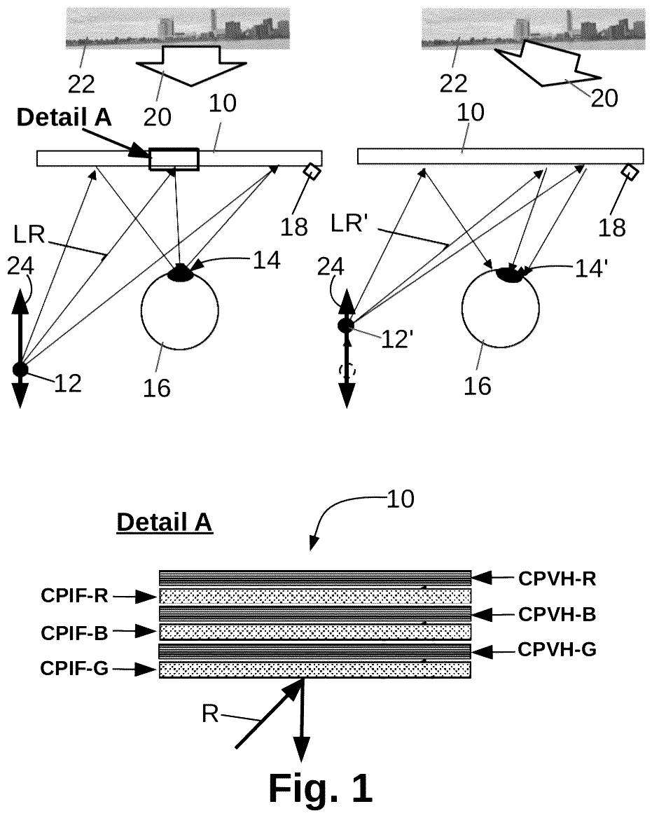

With reference to FIG. 1, a Maxwellian view optical system is shown. In a Maxwellian view optical system, rays from different angles in a projected image all pass though the center of the pupil of the eye. A Maxwellian view optical system is also known as a retinal projection display (RPD). Having all rays entering the pupil at the center, the RPD eliminates the effect of the pupil lens. This creates an image that is always in focus (similar to a “pin hole” camera), and thus minimizes eye strain caused by the vergence/accommodation conflict in three-dimensional VR or AR images. In one approach, the individual rays from the point source are modulated with field-of-view (FOV) information and converged by an optical combiner to the center of the pupil. Diverging rays from the point source are amplitude modulated corresponding to a field of view angle by an image modulator (i.e., spatial light modulator) which modulates amplitude and/or phase of the light. Such a Maxwellian view optical system is suitably used, for example, in implementing a virtual reality (VR) or augmented reality (AR) headset or heads-up display (HUD) device. FIG. 1 diagrammatically illustrates a Maxwellian view optical system an optical combiner 10, a movable point light source 12 (for example, an optical projector 12), along with a contextual diagrammatic representation of a pupil 14 of an eye 16 of a person wearing the VR or AR headset or HUD device. The VR or AR headset or HUD device further includes an eye gaze tracker 18 for tracking rotation of the eye 16. FIG. 1 diagrammatically illustrates one-half of an AR headset or HUD device, e.g., for a left eye—a contralaterally symmetric arrangement is typically provided for the other eye (e.g., a right eye). The gaze tracker 18 measures the rotation of the eyeball 16 (and/or equivalently, movement of the pupil 14). The gaze tracker 18 may, for example, be a camera-based gaze tracker that images the pupil of the eye, as a non-limiting example. The optical combiner 10 of the AR or HUD is optically transparent for light 20 coming in from outside of the AR headset or HUD device so that the light 20 from the real world (diagrammatically shown in FIG. 1 as a city skyline 22) is passed to the eye 14—hence, the wearer (i.e., viewer or user) of the AR headset or HUD device can observe the outside world 22 while wearing the AR or HUD device. (In the case of a VR headset there is typically no need for the optical combiner 10 to be optically transparent.)

As the gaze of the person wearing the VR or AR headset or HUD device shifts by looking to the left or right, the eyeball 16 rotates. Thus, the pupil 14 of the eye 16 is not stationary. FIG. 1 upper lefthand side and upper righthand side show the system for two positions of the eye—looking forward, i.e., straight ahead, as shown on the upper lefthand side; and looking to the right as shown on the upper righthand side. The point light source 12 is shown emitting a light ray LR to the center of the pupil 14 of the eye 16. More particularly, diverging light rays from the projector or other point light source 12 are amplitude- and/or phase-modulated with field of view (FOV) information by a spatial light modulator (not shown) which modulates amplitude and/or phase of the light. The spatial light modulator can be variously embodied, for example using a reflective or transmissive liquid crystal display (LCD), emissive light emitting diode (LED) or organic LED (OLED) display, or so forth. It will be appreciated that the point light source 12 may not be a mathematical point and moreover may emit over a limited solid angle (e.g., emitting light as a cone beam with cone angle of 30° as a nonlimiting illustrative example), but the projector or other point light source 12 is sufficiently spatially compact that it can be approximated as a point for purposes of designing the optical combiner 10.

With continuing reference to FIG. 1, comparison of the upper lefthand and upper righthand diagrams shows that as the gaze moves from straight-ahead (lefthand diagram) to gaze toward the side (righthand diagram), this causes the pupil 14 to translate in position. Left uncorrected, this would result in the optical combiner 10 directing the light rays to a location different from the current location of the pupil 14. To compensate for this, a diagrammatically indicated translation mechanism 24 is provided to move the point light source 12 toward or away from the optical combiner 10 in accord with rotation of the eyeball 16 as monitored by the gaze tracker 18. Moving the point light source 12 toward or away from the plane of the optical combiner 10 operates to steer keep the light ray LR (and all light rays from the point light source 12) centered on the pupil 14. Comparison of FIG. 1, upper lefthand versus upper righthand diagrams illustrates this approach, where the pupil moves from position 14 in the upper lefthand diagram to rotated position 14′ in the upper righthand diagram, and the translation mechanism 24 moves the point light source 12 to the moved position 12′ as shown in the upper righthand diagram to account for this pupil movement. The translation mechanism 24 can be variously implemented, for example as a stepper motor that physically moves the projector or other point light source 12 toward or away from the optical combiner 10, or as a stepper motor that physically moves the optical combiner 10 away from or toward the projector or other point light source 12, or as an electrooptical mechanism such as a mirror arrangement for moving the optical focus of the point light source 12 toward or away from the optical combiner 10, as some nonlimiting illustrative examples.

With continuing reference to FIG. 1, the lower portion illustrates “Detail A” indicated in the upper lefthand diagram. Detail A shows a diagrammatic cross-sectional view of a portion of the optical combiner 10. As seen, the illustrative optical combiner 10 includes three circularly-polarized polarization volume hologram (CPVH) layers, namely: a red CPVH layer designed to deflect red light and designated as CPVH-R (for example, designed for a design-basis wavelength of 635 nm in some illustrative embodiments described herein); a blue CPVH layer designed to deflect blue light and designated as CPVH-B (for example, designed for a design-basis wavelength of 450 nm in some illustrative embodiments described herein); and a green CPVH layer designed to deflect green light and designated as CPVH-G (for example, designed for a design-basis wavelength of 525 nm in some illustrative embodiments described herein). Construction of the optical combiner 10 as made up of three polarization volume hologram (PVH) layers, one designed for blue light, another for green light, and a third for red light, can suppress chromatic aberration. This is because each of the CPVH-R, CPVH-B, and CPVH-G layers can be designed to deflect a corresponding red, blue, or green design-basis wavelength into the pupil 14 of the eye 16. With the three CPVH layers, the CPVH-G layer is designed to deflect green light to the desired angle, the CPVH-B layer is designed to deflect blue light to the same desired angle, and the CPVH-R layer is designed to deflect red light to the same desired angle. By contrast, a single PVH can only be designed to deflect one design-basis wavelength into the pupil 14, and any other wavelength will be deflected into a slightly different angle thus leading to chromatic aberration.

As previously discussed, in such a three-layer optical combiner, each respective layer CPVH-R, CPVH-G, and CPVH-B is designed to be wavelength-selective for the corresponding design-basis wavelength, but should also transmit light of other colors without deflection. Thus, each CPVH layer should be designed with its respective deflection bandwidth sufficiently narrow enough so that it only deflects light of the design-basis color.

However, each respective layer CPVH-R, CPVH-G, and CPVH-B should also be designed to have a wide angle of acceptance. Particularly, with reference again to FIG. 1, upper lefthand and righthand diagrams and with illustrative reference to the central light ray LR, it is seen that as the translation mechanism 24 moves the point light source 12 toward or away from the optical combiner 10, this results in the angle of incidence of the light ray LR changing. Thus, the angle at which the light ray LR shown in the upper lefthand diagram is incident on the optical combiner 10 is different from the angle at which the light ray LR′ shown in the upper righthand diagram is incident on the optical combiner 10. The angle of acceptance of the respective layers CPVH-R, CPVH-G, and CPVH-B of the optical combiner 10 should be large enough to accommodate this angular change. In practice, the change in angle of incidence to accommodate gaze shift in a Maxwellian view optical system can vary by a fairly large amount (e.g., on the order of 15-20 degrees or larger) due to changes in the position of the point light source 12 caused by the translation mechanism 24 in response to rotation of the eyeball 16 measured by the gaze tracker 18.

Hence, the design constraints on the polarization volume holograms of the respective layers CPVH-R, CPVH-G, and CPVH-B are demanding, as both narrow spectral bandwidth and wide angle of acceptance are needed. As will be shown later herein, designing the polarization volume holograms to simultaneously satisfy both the narrow bandwidth and large angle-of-acceptance criteria is difficult or impossible.

With continuing reference to FIG. 1, now referring back to Detail A, this problem is overcome in the illustrative optical combiner 10 by further including polarization interference filter (PIF) layers that switch the light polarization between a first polarization (e.g., right-circularly polarized, or RCP) to a second polarization (e.g., left-circularly polarized, or LCP) over a narrow bandwidth. The respective layers CPVH-R, CPVH-G, and CPVH-B are then designed to deflect light of only one of these polarizations, namely LCP in most examples described herein. In the illustrative optical combiner 10 of Detail A, there are three PIF layers, namely: a red PIF layer designed to switch circular polarization of red light between RCP and LCP and designated as CPIF-R; a blue PIF layer designed to switch circular polarization of blue light between RCP and LCP and designated as CPIF-B; and a green PIF layer designed to switch circular polarization of green light between RCP and LCP and designated as CPIF-G. (The leading “C” in the acronyms CPIF-R, CPIF-B, and CPIF-G indicates the polarization interference filters are designed to selectively switch polarization of circularly polarized light.)

As further disclosed herein, by way of the further included PIF layers CPIF-R, CPIF-B, and CPIF-G, the stringent narrow bandwidth requirement on the respective polarization volume hologram layers CPVH-R, CPVH-G, and CPVH-B can be relaxed since the polarization interference filters CPIF-R, CPIF-B, and CPIF-G provide for narrowband operation, and so the resulting optical combiner 10 can be designed to achieve both wide angle of acceptance and low chromatic aberration performance. The low chromatic aberration is achieved because the PVH layers are of sufficiently narrow spectral bandwidth to avoid color crosstalk, such as red light being erroneously deflected by the CPVH-G layer.

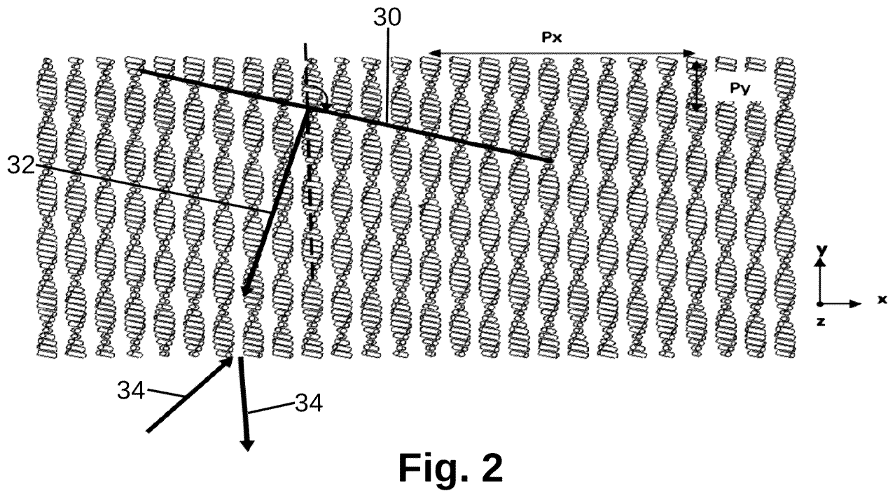

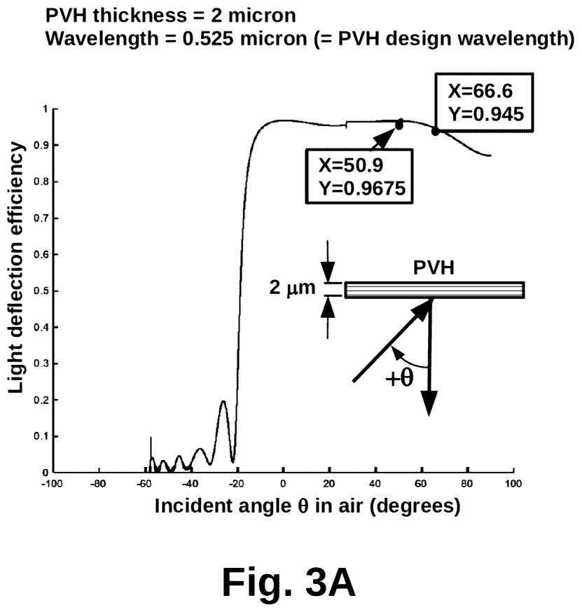

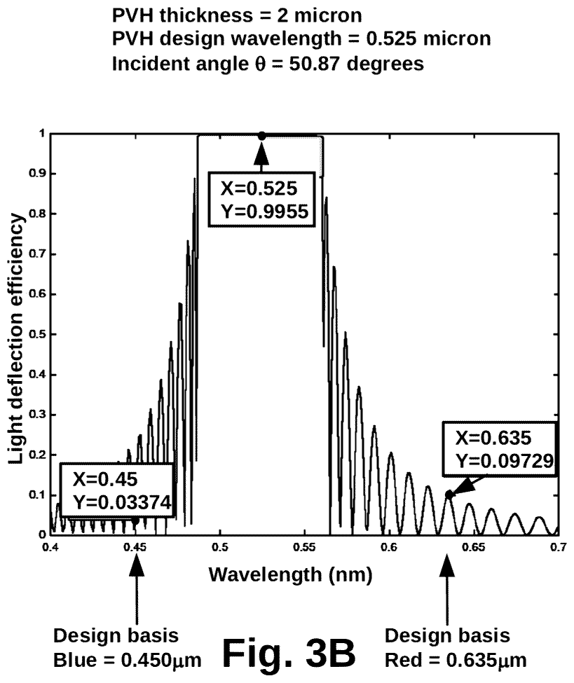

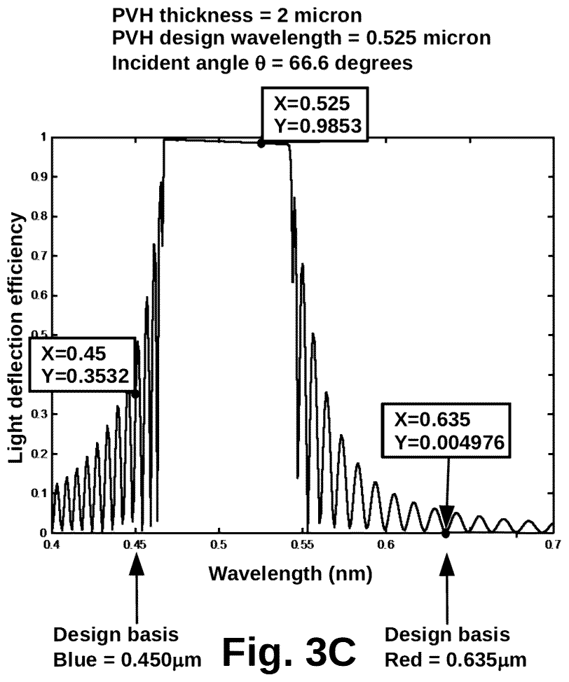

With reference now to FIGS. 2 and 3A, 3B, and 3C, before further discussing the benefits of the polarization interference filters CPIF-R, CPIF-B, and CPIF-G, the difficulty of designing an optical combiner without these layers to have both wide angle of acceptance and low chromatic aberration is further described. FIG. 2 diagrammatically illustrates the green CPVH-G layer (the CPVH-R and CPVH-B layers are similar but with different periodicities). For descriptive purposes, the following coordinate system is used as indicated in FIG. 2: +x is pointing right, +y is pointing up (cell normal direction), and +z is pointing out of the page towards reader. The line 30 is the Bragg plane, which makes an angle of 104.125 degree with +y direction. The arrow 32 is the grating vector at 194.125 degrees with +y direction. The arrows 34 and 36 indicate the incident beam 34 and deflected beam 36, respectively, with the incident beam 34 at 50.87 with +y direction and the deflected beam 36 at 1.2 degrees with −y direction in air. To design an optical combiner that deflects red, green, and blue light to the same angle (without the polarization interference filters), three CPVH layers are provided, where each layer is designed to deflect red, green, or blue light, respectively, to a common angle. For the grating shown in FIG. 2 designed as a CPVH-G for θᵢₙ=50.87 degree, θ_{def}=1.2 degree as just noted, and for a green light wavelength of λ=525 nm), the angular and wavelength dependence of the deflected efficiency can be determined. The CPVH-G has a refractive index of nₓ=1.7, n_{y}=n_{z}=1.5. The horizontal pitch Px indicated in FIG. 2 is 0.6956 micron, and the pitch Py along the thickness direction indicated in FIG. 2 is 0.1750 micron. FIG. 3A shows the angle of acceptance of this green PVH, whose thickness is 2 microns. Specifically, FIG. 3A plots the simulated light deflection efficiency versus incident angle (indicated as incident angle θ in FIGS. 3A, 3B, and 3C). As labeled in FIG. 3A, at both incidence angle 50.87 degrees and incident angle 66.6 degrees the light deflection efficiency is high, at greater than 94% efficiency. Hence, this PVH has been designed for wide angle of acceptance (>15 degrees) for the design basis green light (525 nm). However, this comes at the cost of unacceptably wide spectral bandwidth, as illustrated by the simulated spectra of FIGS. 3B and 3C which show that the green PVH will also deflect a substantial amount of light in the blue (labeled for 0.45 micron) and red (labeled for 0.635 micron). This constitutes undesirable deflection contributing to chromatic aberration.

FIGS. 2 and 3A, 3B, and 3C illustrate the fundamental problem with designing a polarization volume hologram for both low chromatic aberration and large acceptance angle. To design a CPVH with a narrow spectral bandwidth of deflection wavelengths, the main parameter that is adjusted to obtain this is to lower the degree of index modulation. However, increasing birefringence leads to a monotonic increase of both the wavelength spectrum and angle of acceptance. In other words, to increase the angle of acceptance, the index modulation is lowered—but lowering the index modulation to increase the angle of acceptance also simultaneously increases the spectral bandwidth thereby increasing chromatic aberration. See, e.g., Xiang and Escuti, “Numerical analysis of Bragg polarization gratings”, J. Opt. Soc. Am. B 36, D1-D8 (2019). Hence, it is difficult or impossible to design a full-color optical combiner with both low chromatic aberration and large angle of acceptance to accommodate movement of the point light source 12 by the translation mechanism 24.

This problem is solved by the optical combiner 10 of FIG. 1, by including the CPIF layers to decouple the problem of providing large angle of acceptance and narrow spectral bandwidth. Each CPVH layer can be designed to beneficially have a large angle of acceptance, and consequently a large spectral bandwidth. The large spectral bandwidth is ordinarily a problem. This is overcome as follows. The CPVH is designed to only interact with light of a particular polarization (e.g., only left-circular polarization). The corresponding PIF is designed to switch light to that particular polarization over only a narrow spectral bandwidth, which is narrower than the larger spectral bandwidth of the corresponding CPVH. Hence, the PIF operates to effectively narrow the operative spectral bandwidth of the corresponding CPVH.

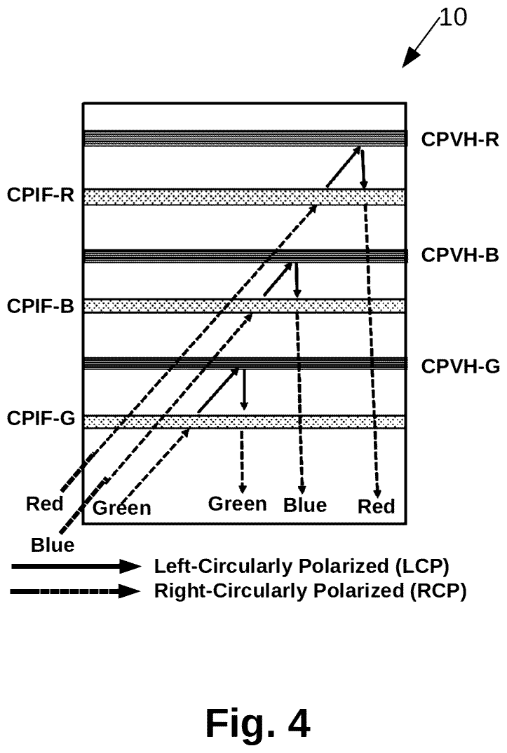

With reference now to FIG. 4, an exploded side-sectional view of the optical combiner 10 of FIG. 1 is shown. The optical combiner 10 has a light incidence side which may be the first PIF (in this case, CPIF-G). Alternatively, if the optical combiner 10 has a transparent front cover (not shown) then the first PIF (here CPIF-G) is disposed between the light incidence side of the optical combiner (e.g., the transparent front cover) and the first PVH (here CPVH-G). The view of FIG. 4 is exploded in that the constituent layers: CPIF-G, CPVH-G, CPIF-B, CPVH-B, CPIF-R, and CPVH-R, are spaced apart from one another so that the light rays can be better shown. In FIG. 4, it is seen how each color (R, G, or B) is affected by the CPIF and CPVH layers of the optical combiner 10. Each of the three CPVH layers (CPVH-G, CPVH-B, and CPVH-R) are in this nonlimiting illustrative example designed to deflect left-circularly polarized (LCP) light, and to transmit right-circularly polarized (RCP) light. Considering blue RCP incident light as an example, the green CPIF-G has no effect on the polarization state of RCP blue light, and the RCP blue light is passed through the green CPVH-G. This will happen even if CPVH-G has a broad deflection wavelength spectral bandwidth that may encompass blue light and hence allow the deflection of LCP blue light, because the incident blue light is RCP. Next the RCP blue light interacts with the blue CPIF-B that changes (i.e., switches) its polarization state to LCP. The now-LCP blue light then encounters the blue CPVH-B and is deflected by it. The deflected LCP blue light is then converted by its second encounter with the blue CPIF-B back to be RCP blue light that is unaffected by the green CPVH-G.

Notably, in the example of FIG. 4 the incident light is assumed to be RCP. To achieve this, a circular polarizer (not shown) is suitably incorporated into the point light source 12 or is interposed between the point light source 12 and the optical combiner 10. For example, the circular polarizer can be constructed as a combination of a linear polarizer filter and a quarter-wave plate.

A more detailed example follows.

Polarization volume holograms are similar to Bragg reflectors, but only respond to a defined polarization state of light. For a CPVH, that defined polarization of light is a circular polarization (e.g., LCP, or RCP, depending on the design). CPVH devices are designed with a spiraling optic axis (see FIG. 2) that has a period defined by the desired deflection angle and for a particular wavelength. The reflection efficiency of CPVH devices is affected by a change in incident wavelength and by a change in incident angle. Also, for wavelengths different from the design wavelength the deflected angle of incident light will be a function of wavelength. Furthermore, increasing the degree of the refractive index modulation (which is a function of the period of the optic axis spiral) increases the efficiency of the CPVH device with regard to both the range of incident wavelengths (i.e., spectral bandwidth) and the incident angle (i.e., angle of acceptance). In a CPVH the degree of refractive index modulation is set by the birefringence of the material used to construct it.

In this example, the CPVHs has nx=1.7 and ny=nz=1.5. The green PVH director is shown in FIG. 2. The other two PVHs have the same Bragg plane angle and grating vector angle as shown in FIG. 2, but the pitch of the spiraling optic axis is changed as shown in Table 1.

TABLE 1
horizontal and vertical pitch of the CPVH used in this work.
Length unit for pitch is micron

| | Px (horizontal | Py (pitch along the |
|---|---|---|
| | pitch) | thickness direction) |
| Blue CPVH | 0.5962 | 0.1500 |
| Green CPVH | 0.6956 | 0.1750 |
| Red CPVH | 0.8413 | 0.2117 |

Polarization interference filters (PIFs) are wavelength selective filters that are based on the effect the filter has on polarized light. A particular type of PIF, here used as an example device, is what is referred to as a Solc filter. This device, used as a sensitive wavelength selective filter for spectroscopy, consists of a stack of “half-wave retarders” (HWRs). These half wave retarders are layers of a birefringent material partially characterized by the difference in the index of refraction measured using normally incident, linear polarized light, for polarization states parallel and perpendicular to the optic axis of the material. This difference in the index of refraction, measured in this way, is called the birefringence (Δn). They are further characterized as having the property of the value of the product of their thickness (d) with Δn to be equal to the wavelength of the design vacuum wavelength (λo) divided by two. That is: Δ2*d=λo/2.

In the particular example PIF used in the description of this example, a particular type of Solc filter is considered where the optic axis of the HWRs in the Solc filter stack are “rocking” between + and − values of a defined angle. The defined angle is related to the number of HWRs in the stack and is given by:

|p|=180/(4*N) (1)

where p is the angle and N is number of HWRs. The narrowness of the range of wavelengths of light affected by the Solc PIF is affected by N: the larger the value of N, the narrower the range of affected wavelengths. Again, what is meant by affected wavelengths, are those wavelengths that have their linear polarization state changed to an orthogonal state. Wavelengths are not affected by the PIF have their polarization state unchanged.

In the optical combiner 10, it is desired to combine the properties of the above described PIF and CPVH devices. However, PIF devices for astronomy applications are designed to affect the polarization state of linearly polarized light, whereas the CPVH is designed to affect light of a particular circular polarization state. Also, PIF devices have strong angular dependence. That is, that the range of wavelengths affected by the PIF is a function of the incident angle of light.

For the present example employing circularly polarized light, the property of the PIF to operate with linear polarized light is modified by the addition of two “quarter wave retarders” (QWRs). QWRs are known to be able to convert light from being linearly polarized to circularly polarized for a particular design wavelength. The design wavelength of the QWRs is fixed by the equation:

Δn*d=λo/4 (2)

These retarders, like the HWRs, have their optic axis perpendicular to the plane of the layers. The rotation angle of the optic axis of the QWRs about an axis perpendicular to the plane of the layers is +/−45 degrees to the axis of polarization axis of input or output linearly polarized light. The sign of the angle determines if the incident linear polarized light will be converted to LHC or RHC, or conversely if incident LHC (for example) will be converted to linearly polarized light with polarization axis at + or −45 degrees. An example design of the CPIF includes a stack of 14 retarders where each retarder has its optic axis in the plane of the stack. These retarders are specified by their value of Δn*d/λ=ΔΓ, and by the angle their optic axis makes with respect to a fixed axis in the plane of the stack, φ. Table 2 gives the values of each of the 14 retarders in an example CPIF stack

TABLE 2
Definition of an example CPIF

| Retarder | | |
|---|---|---|
| number | ΔΓ | ϕ |
| 1 | ¼ | +45 |
| 2 | ½ | +3.75 |
| 3 | ½ | −3.75 |
| 4 | ½ | +3.75 |
| 6 | ½ | −3.75 |
| 7 | ½ | +3.75 |
| 8 | ½ | −3.75 |
| 9 | ½ | +3.75 |
| 10 | ½ | −3.75 |
| 11 | ½ | +3.75 |
| 12 | ½ | −3.75 |
| 13 | ½ | +3.75 |
| 14 | ¼ | −45 |

The property of the PIF to shift its range of affected wavelengths as a function of angle is modified by the substitution of typical uniaxial HWRs with biaxial versions. While there are several designs for wide angle retarders, in the example system considered here, Nz type retarders are modeled. Nz type retarders have the value of the index of refraction for light polarized along the normal to the plane of the film to be the average value of the two indices of refraction measured for light polarized in orthogonal directions in the plane of the film. There are other types of retarder designs that can be used to provide angular independent operation. For example, suitably designed multiple uniaxial retarders may be substituted in the place of an Nz type retarder.

The optical properties of the designed device were calculated with a numerical optical calculation method. Tables 3 and 4 show the percentage of light deflected to the desired angle (Main Deflection), and the percentage of light deflected to incorrect angles (cross talk). This is shown for the case of using the disclosed optical combiner 10 with CPIF-G, CPIF-B, and CPIF-R and for the case in which the CPIFs are omitted.

TABLE 3
Efficiencies of the simulated cases with/without CPIF
for 50.87 degree incidence

| | | | 2^{nd} | Cross | | |
|---|---|---|---|---|---|---|
| | | Largest | largest | talk | Main/ | |
| Case | Main | cross | cross | peaks | cross | Transmitted |
| name | deflection | talk | talk | source | ratio | beam |
| 635 nm | 89.9% | 2.5% | 1.9% | Green | 20.4 | 3.7% |
| with no | | | | PVH | | |
| CPIF | | | | | | |
| 635 nm | 96.0% | 0.006% | 0.03% | N/A | 2666.7 | 4.1% |
| with CPIF | | | | | | |
| 450 nm | 76% | 21.1% | N/A | Green | 3.6 | 2.0% |
| with no | | | | PVH | | |
| CPIF | | | | | | |
| 450 nm | 94.2% | 0.1% | N/A | N/A | 942.0 | 4.5% |
| with CPIF | | | | | | |
| 525 nm | 98.0% | N/A | N/A | N/A | — | 2.6% |
| with no | | | | | | |
| CPIF | | | | | | |
| 525 nm | 96.0% | N/A | N/A | N/A | — | 4.5% |
| with CPIF | | | | | | |

In Table 3, the main deflection is integrated from [−3.8,5.4] degree range. “main/cross ratio” in the second-to-last column of Table 3 refers to the ratio of the main deflection peak over the cross-talk peak. The transmitted beam is integrated from [40,90] degree range. In the table elements, “N/A” indicates “Not clearly observed”. In the design, as shown in FIG. 4, the green CPVH-G is the first CPVH in the stack, and so the “Main/cross ratio” is not applicable, as indicated by “---” in Table 3.

TABLE 4
Efficiencies of the simulated cases with/without CPIF
for 66.6 degree incidence

| | | | 2^{nd} | Cross | | |
|---|---|---|---|---|---|---|
| | | Largest | largest | talk | Main/ | |
| Case | Main | cross | cross | peaks | cross | Transmitted |
| name | deflection | talk | talk | source | ratio | beam |
| 635 nm | 78.0% | 3.0% | 1.2% | Green | 18.6 | 15.0% |
| with no | | | | PVH | | |
| CPIF | | | | | | |
| 635 nm | 95.1% | 0.04% | 0.01% | N/A | 1902.0 | 4.3% |
| with CPIF | | | | | | |
| 450 nm | 63.0% | 20.4% | 4.7% | Green | 2.5 | 9.8% |
| with no | | | | PVH | | |
| CPIF | | | | | | |
| 450 nm | 83.7% | 0.02% | 0.8% | N/A | 102.1 | 13.3% |
| with CPIF | | | | | | |
| 525 nm | 96.2% | N/A | N/A | N/A | — | 4.1% |
| with no | | | | | | |
| CPIF | | | | | | |
| 525 nm | 90.8% | N/A | N/A | N/A | — | 8.2% |
| with CPIF | | | | | | |

In Table 4, the main deflection is integrated from [5.4,13.8] degree range. “main/cross ratio” in the second-to-last column of Table 4 refers to the ratio of the main deflection peak over the cross-talk peak. The transmitted beam is integrated from [54.6,90] degree range. In the table elements, “N/A” indicates “Not clearly observed”. In the design, as shown in FIG. 4, the green CPVH-G is the first CPVH in the stack, and so the “Main/cross ratio” is not applicable, as indicated by “---” in Table 4.

The calculated results presented in Tables 3 and 4 indicate that the inclusion of the PIFs in the optical combiner 10 provide for the deflected angle for the three considered colors of light (red, green, and blue) to be the same, with very little crosstalk between the colors. Such crosstalk between colors manifests as undesirable chromatic aberration.

In the example of Tables 3 and 4, the light angle is varied by positive 16 degrees from the optimized angle. However, calculations over a negative 16 degrees also provided a good result, indicating the range of incident angles usable when incorporating the PIFs is greater than 30 degrees.

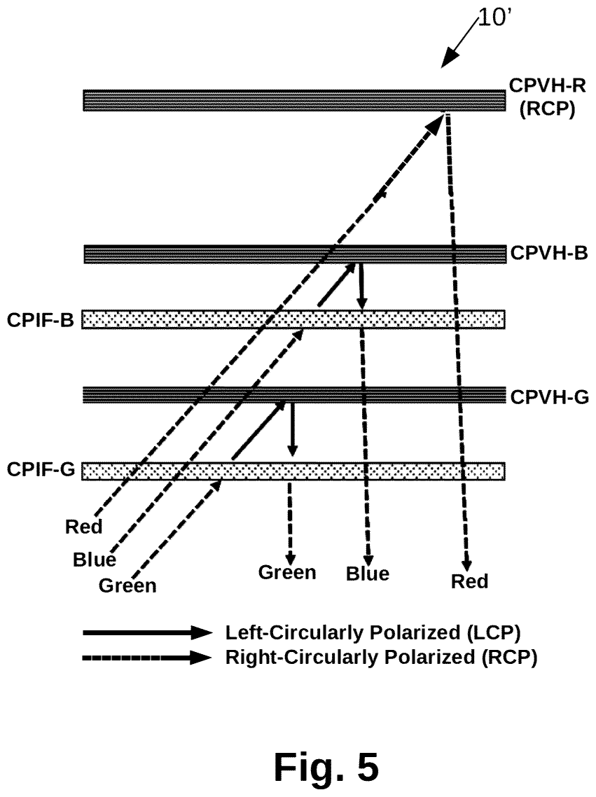

With reference to FIG. 5, another optical combiner 10′ is shown, which differs from the embodiment of FIG. 4 in two ways. First, CPIF-R is omitted. Second, CPVH-R is modified to deflect RCP red light. The design of FIG. 5 advantageously omits one CPIF (namely CPIF-R) while retaining its function. The embodiment of FIG. 5 again operates with RCP incident light.

It is also noted that in the embodiments of both FIG. 4 and FIG. 5, it is contemplated for CPVH-R to deflect both RCP and LCP red light. This is because there is no need for CPVH-R, which is the last CPVH encountered by the light, to pass green or blue light.

Furthermore, in either the design of FIG. 4 or the design of FIG. 5, the LCP and RCP light could be reversed, e.g., in the embodiment of FIG. 4 the incident light could be LCP light and the CPVH layers could be designed to reflect only RCP light, opposite to what is shown. Still further, if the layers are made of a birefringent material operative with linearly polarized light, rather than circularly polarized light, the CPIF could be replaced by linear PIF layers that switch between two orthogonal linear light polarization, and likewise the CPVH layers could be replaced by PVH layers that selectively deflect linearly polarized light of a designed polarization.

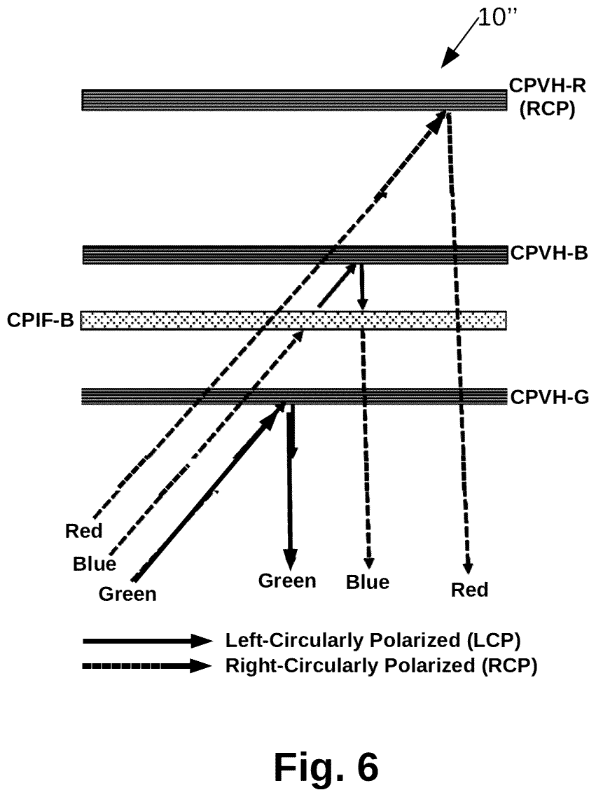

With reference to FIG. 6, another optical combiner 10″ is shown, which further reduces the number of PIF layers to a single PIF layer (CPIF-B). However, to utilize the optical combiner 10″, the incident light of the color whose CPVH is first encountered (green in this example, since CPVH-G is the bottommost CPVH) is of opposite polarization (illustrative LCP) compared with the other two colors (RCP for blue and green in the illustrative example of FIG. 6).

In the illustrative designs, the CPVH layers of the optical combiner are arranged in the order: green CPVH-G, blue CPVH-B, and red CPVH-R, where the incident light impinges first on green CPVH-G. This order is beneficial since the human eye is most sensitive to green light. However, other orderings of the three colors are contemplated. Moreover, the specific center wavelength of the three colors can be different from those of the illustrative examples, and the three colors corresponding to the design-basis wavelength of the three CPVH's could be other than red, green, and blue.

It will be appreciated that various of the above-disclosed and other features and functions, or alternatives thereof, may be desirably combined into many other different systems or applications. It will be further appreciated that various presently unforeseen or unanticipated alternatives, modifications, variations or improvements therein may be subsequently made by those skilled in the art which are also intended to be encompassed by the following claims.

1. A device comprising:
an optical combiner including:
a first polarization volume hologram (PVH) configured to deflect light of a first color;
a second PVH configured to deflect light of a second color that is different from the first color;
a third PVH configured to deflect light of a third color that is different from the first and second colors; and
a first polarization interference filter (PIF) configured to switch light of the first color from a polarization that is not deflected by the first PVH to a polarization that is deflected by the first PVH.

2. The device of claim 1 wherein the optical combiner further includes:
a second PIF configured to switch light of the second color from a polarization that is not deflected by the second PVH to a polarization that is deflected by the second PVH.

3. The device of claim 2 wherein:
the first PVH deflects light of a first polarization and does not deflect light of a second polarization;
the second PVH deflects light of the first polarization and does not deflect light of the second polarization;
the third PVH deflects light of the second polarization;
the first PIF is configured to switch light of the first color from the second polarization to the first polarization;
the second PIF is configured to switch light of the second color from the second polarization to the first polarization;
the first PIF is disposed between a light input side of the optical combiner and the first PVH;
the second PIF is disposed between the light input side of the optical combiner and the second PVH; and
both the first PIF and the second PIF are disposed between the light input side of the optical combiner and the third PVH.

4. The device of claim 2 wherein the optical combiner further includes:
a third PIF configured to switch light of the third color from a polarization that is not deflected by the third PVH to a polarization that is deflected by the third PVH.

5. The device of claim 4 wherein:
each of the first PVH, the second PVH, and the third PVH deflects light of a first polarization and does not deflect light of a second polarization;
the first PIF is configured to switch light of the first color from the second polarization to the first polarization;
the second PIF is configured to switch light of the second color from the second polarization to the first polarization;
the third PIF is configured to switch light of the third color from the second polarization to the first polarization;
the first PIF is disposed between a light input side of the optical combiner and the first PVH;
the second PIF is disposed between the light input side of the optical combiner and the second PVH; and
the third PIF is disposed between the light input side of the optical combiner and the third PVH.

6. The device of claim 4 wherein:
a spectral bandwidth of the first PVH is larger than a spectral bandwidth of the first PIF;
a spectral bandwidth of the second PVH is larger than a spectral bandwidth of the second PIF; and
a spectral bandwidth of the third PVH is larger than a spectral bandwidth of the third PIF.

7. The device of claim 2 wherein:
a spectral bandwidth of the first PVH is larger than a spectral bandwidth of the first PIF; and
a spectral bandwidth of the second PVH is larger than a spectral bandwidth of the second PIF.

8. The device of claim 1 wherein:
a spectral bandwidth of the first PVH is larger than a spectral bandwidth of the first PIF.

9. The device of claim 1 wherein:
the first color is one of the group consisting of a green color, a blue color, and a red color;
the second color is one of the group consisting of the green color, the blue color, and the red color; and
the third color is one of the group consisting of the green color, the blue color, and the red color.

10. A device comprising:
an optical combiner including:
a first polarization volume hologram (PVH) configured to deflect light of a first color and having a first polarization and configured to not deflect light of the first color and having a second polarization;
a second PVH configured to deflect light of a second color and having the first polarization and configured to not deflect light of the second color and having the second polarization;
a third PVH configured to deflect light of a third color and having the first polarization and configured to not deflect light of the third color and having the second polarization;
a first polarization interference filter (PIF) configured to switch light of the first color from the second polarization to the first polarization;
a second PIF configured to switch light of the second color from the second polarization to the first polarization; and
a third PIF configured to switch light of the third color from the second polarization to the first polarization;
wherein:
the first PVH is disposed between the first PIF and the second PIF,
the second PVH is disposed between the second PIF and the third PIF, and
the third PIF is disposed between the second PVH and the third PVH.

11. The device of claim 10 wherein:
a spectral bandwidth of the first PIF does not encompass the second color and does not encompass the third color;
a spectral bandwidth of the second PIF does not encompass the first color and does not encompass the third color; and
a spectral bandwidth of the third PIF does not encompass the first color and does not encompass the second color.

12. The device of claim 11 wherein:
a spectral bandwidth of the first PVH is larger than the spectral bandwidth of the first PIF;
a spectral bandwidth of the second PVH is larger than the spectral bandwidth of the second PIF; and
a spectral bandwidth of the third PVH is larger than the spectral bandwidth of the third PIF.

13. The device of claim 12 wherein:
the spectral bandwidth of the first PVH encompasses at least one of the second color and/or the third color;
the spectral bandwidth of the second PVH encompasses at least one of the first color and/or the third color;
the spectral bandwidth of the third PVH encompasses at least one of the first color and/or the second color;

14. The device of claim 10 wherein:
the first polarization is one of the group consisting of left-circularly polarized and right-circularly polarized; and
the second polarization is the other of the group consisting of left-circularly polarized and right-circularly polarized.

15. The device of claim 10 further comprising:
a light source arranged to direct light of the second polarization onto a light incidence side of the optical combiner, wherein the first PIF comprises the light incidence side of the optical combiner or is disposed between the light incidence side of the optical combiner and the first PVH; and
a virtual reality (VR) or augmented reality (AR) headset or a heads-up display (HUD) device including the optical combiner, the light source, a gaze tracker, and a translation mechanism operative to move the light source toward or away from the optical combiner in accord with a rotation of the eyeball monitored by the gaze tracker.

16. A device comprising:
an optical combiner including:
a first polarization volume hologram (PVH) configured to deflect light of a first color and having a first polarization and configured to not deflect light of the first color and having a second polarization;
a second PVH configured to deflect light of a second color and having the first polarization and configured to not deflect light of the second color and having the second polarization;
a third PVH configured to deflect light of a third color and having the second polarization;
a first polarization interference filter (PIF) configured to switch light of the first color from the second polarization to the first polarization; and
a second PIF configured to switch light of the second color from the second polarization to the first polarization;
wherein:
the first PVH is disposed between the first PIF and the second PIF,
the second PIF is disposed between the first PVH and the second PVH, and
the second PVH is disposed between the second PIF and the third PVH.

17. The device of claim 16 wherein:
a spectral bandwidth of the first PIF does not encompass the second color and does not encompass the third color; and
a spectral bandwidth of the second PIF does not encompass the first color and does not encompass the third color.

18. The device of claim 17 wherein:
a spectral bandwidth of the first PVH is larger than the spectral bandwidth of the first PIF; and
a spectral bandwidth of the second PVH is larger than the spectral bandwidth of the second PIF.

19. The device of claim 16 wherein:
the first polarization is one of the group consisting of left-circularly polarized and right-circularly polarized; and
the second polarization is the other of the group consisting of left-circularly polarized and right-circularly polarized.

20. The device of claim 16 further comprising:
a light source arranged to direct light of the second polarization onto a light incidence side of the optical combiner, wherein the first PIF comprises the light incidence side of the optical combiner or is disposed between the light incidence side of the optical combiner and the first PVH; and
a virtual reality (VR) or augmented reality (AR) headset or a heads-up display (HUD) device including the optical combiner, the light source, a gaze tracker, and a translation mechanism operative to move the light source toward or away from the optical combiner in accord with a rotation of the eyeball monitored by the gaze tracker.
